(19) United States
(12) Patent Application Publication
(10) Pub. No.: US 2005/0069624 A1
(43) Pub. Date: Mar. 31, 2005

(54) Fried animal skin products

(76) Inventor: Shangwu Liu, Lingxi Cangnan Wenzhou Zhejiang (CN)

Correspondence Address: Christopher J. Whewell;Western Patent Group, 6020 Tonkowa Trail, Georgetown, TX, 78628, US

(21) Appl. No.: 10/673,981

(22) Filed: Sep. 30, 2003

(51) Int. Cl. A23L 1/31

(52) U.S. Cl. 426/645

(57) ABSTRACT

Provided herein is a process for producing fried animal skin products which are useful among other things as snack treats for domestic pets, such as dogs. A fried animal skin according to the invention has a high resistance to an applied crushing stress, which renders a fried skin product according to the invention to be well-suited to be chewed on by dogs while not being readily consumable by dogs in too quick a time frame. A fried skin product according to a preferred form of the invention contains no artificial colorants or flavorants, and is highly appealing to dogs of all breeds.

### TECHNICAL FIELD

This invention relates to snack treats for domestic pets. More particularly, it relates to fried pork skin treats intended for consumption primarily by domesticated canines. A fried pork skin prepared in accordance with a process according to the present invention has unique properties over fried pork skins provided in accordance with prior art methods.

### BACKGROUND

Various snack foods are available for domesticated pets, such as dogs and cats. While it is possible to provide a snack food to a pet that the pet can readily chew and swallow quickly, such as MILK-BONE® dog biscuits and the like, a pet which eats a chewable snack is only satisfied for that short amount of time that they are chewing and swallowing the snack, and once it is eaten, the pet remains largely as it was previous to eating the snack.

Young dogs, especially those aged from 2 months to 2 years, are prone to exercising a strong chewing instinct. That is to say, puppies and adolescent dogs are known to chew nearly anything in sight. For dogs in this age category especially, it is beneficial to provide the animal with a chewable item which they can chew on in order to work out their frustrations associated with their instinct to chew. Historically, rawhides of cattle have proven to be the traditional choice of material used in this regard.

However, another pet snack food item that has come into popular use in recent years is the pig ear snack for dogs. Pig ears are merely the cartilage portion of the ear of swine which have been dried or otherwise treated to yield a hard, leather-like treat which may be chewed by the pet for an extended time. Swine ears are relatively expensive, however, typically costing over one dollar each at the retail level. However, the skin of swine is much more abundant than ears, for the obvious reason that there is more surface area of skin on a pig's body than there is associated with the ears. Thus, one raw material which is available but which has not been tapped for the pet snack market is the skin of swine.

In general, pork skins have a tough, leathery consistency. It is well-known that these tough pork skins can be boiled and then fried in hot oil to produce puffed pork “cracklings”, which are popular snacks among some humans. The cracklings are crisp and have a mild bacon flavor. The production of pork cracklings domestically entails serious drawbacks, however, primarily due to the use of oil or butter at elevated temperatures of 200° C. or higher. Fried puffed pork products are available commercially, but contain relatively high amounts of fat.

A pork rind product is described in U.S. Pat. No. 3,401,045, which is prepared by cutting pork rinds or skins into small pieces and rendering the skins at temperatures in the range from 235-255° F. to harden the rinds or skins and reduce their size. The pork skins are rendered in hot oil or fat, cured in an aqueous curing or flavoring solution and then dried. The dried pieces of pork skin are then cooked in vegetable oil or shortening to puff the pork skin pieces at temperatures from about 400-425° F. Such fried pork puffed products have the disadvantage that they contain large amounts of fats and oils, which have been found to contribute to heart disease and atherosclerosis.

U.S. Pat. No. 2,855,309 discloses pre-treating pork rinds in an acetic acid solution to improve the puffing qualities of pork rinds. The acetic acid treated pork rinds are then fried in hot oil.

French Patent 2,501,970 teaches making a pork rind snack product by cooking pork rinds in boiling water and skimming off the resulting fats. After flavoring, the pork rinds are dried and then briefly scalded in frying oil at approximately 140° C. After frying, the fried pork products are again fried at approximately 180° C. to effect prolonged sealing or cooked in a microwave oven.

A puffable pork food pellet is disclosed in U.S. Pat. No. 3,725,084. The puffable pellet is prepared by forcing moisture into the spaces in the molecular structure of pork skins using steam under predetermined temperature and pressure conditions. Uniform distribution of moisture causes uniform puffing of the pork skins when the moisturized skins are cooked or French fried in fat at high temperatures.

Pork snack products are also known in which the pork rinds are further processed into a gel or slurry and then puffed by means of an extruder. U.S. Pat. No. 3,793,467 discloses a method of removing hair normally associated with commercially available pork rinds by comminuting pork rinds to a relatively small particle size, suspending and slurring the pork rinds in a liquid medium to dislodge associated hair and then separating the hair from the pork rinds. The pork rinds are then dried to a moisture content below 20% and extruded in a conventional food screw extruder in a gelatinized state in which a heated die cooks and puffs the gelatinized extrudate.

U.S. Pat. No. 4,119,742 discloses a reconstituted fried and puffed product prepared by moisturizing animal parts which are high in collagen and at least 50% of which are rendered parts. Gelatinized particles are extruded, cut into small pellets, dried and deep fat fried to produce a puffed pork product.

U.S. Pat. No. 4,262,028 discloses a puffable food composition prepared by extruding a mixture of ground animal parts and starch as a partially gelatinized mixture into a shape-sustaining form. The gelatinized form is then puffed in the heated die of the extruder or by subsequent hot oil frying.

An expanded textured protein product is disclosed by U.S. Pat. No. 3,662,673. The textured protein product contains oleaginous seed materials and an aqueous liquid which can be internally heated by an infrared, microwave or induction oven to expand the mixture forming an irreversibly cross-linked structure.

Processes for preparing puffable foodstuffs are disclosed by U.S. Pat. Nos. 4,608,261 and 4,525,367. The former patent discloses a helical screw conveyor for processing a raw foodstuff in particulate form, preheating the particulate foodstuff in a preheating chamber and then subjecting the preheated food to heating by microwave energy. Moist, edible ingredients are disclosed in the latter patent which are contained in a confining structure which can be burst by pressure generated by food or gas expansion. A confining structure is also used to contain the expanded mixture after heating and rupture.

Thus, fat fried pork products are well-known, but suffer from the disadvantage that they contain substantial amounts of fats which have been implicated in serious health problems. In addition, fried pork skin products of the prior art readily yield to forces between the upper and lower jaw which are on the order of those required to chew through a corn puff or a potato chip, which means that an animal to whom a fried pork skin product according to the prior art is fed will devour such a snack treat in a very short time frame, rendering such prior art fried pork skin products unfit for use as dog treats of any substantial longevity.

Thus, there is a need in the art for a healthy and relatively low-fat puffed pork skin snack product which is not readily devoured by an animal to which it is fed. The present invention provides such a puffed pork product snack.

### SUMMARY OF THE INVENTION

The present invention provides a process for producing an edible fried pork skin comprising the steps of: a) contacting a raw pork skin with an alkaline aqueous solution for an effective amount of time to remove the hair from said skin; b) splitting said skin into a plurality of layers having a thickness dimension less than that of the original skin; c) removing the fat from the surface of said plurality of layers of skin; d) washing said plurality of layers of skin in water to provide a washed skin product; e) treating said washed skin product with an intenerate solution to provide a tenderized skin product; f) washing the tenderized skin product with water; g) treating the tenderized skin product with aqueous acid to provide an acidified skin product; h) treating said acidified skin product with aqueous hydrogen peroxide to provide a treated skin product; i) drying said treated skin product and cutting it into desired shapes; j) frying the treated skin product in an oil at a frying temperature to provide a fried skin product; and k) drying said fried skin product at an elevated temperature.

According to one alternate form of the invention, steps b), c), and d) are omitted from the above procedure to provide a pet snack product based on the complete animal skin which has been unchanged from its initial state with regards to its thickness dimension.

According to another embodiment, the process the frying step is replaced by roasting the treated skin product at a temperature in the range of between 200 degrees centigrade and 250 degrees centigrade for a timer period between about 5 minutes and 15 minutes.

### DETAILED DESCRIPTION

The present invention provides a process for producing an edible fried pork skin product which has a hard outer surface and is especially well suited for use as treats for pets such as dogs which tend to consume ordinary fried pork skin products too rapidly for conventional fried pork skins to be effectively employed in such a use. As is known in the art, pork snack products intended for human consumption are relatively easy to bite, typically requiring mandible force on the order of that required to bite through a fried potato chip. Thus, fried pork rinds having such a low yield to jaw pressure would only be enjoyed by a pet such as a dog for a very short time, as any dog can easily chew through and swallow a fried pork rind that has been manufactured for human consumption in a matter of seconds. Such fried pork rinds are unsuitable as pet snacks when the intent is for a pet to enjoy chewing on the snack for an extended time period, which is generally preferably from about 1 minute to 10 minutes for a single snack.

By my invention I have devised a method for producing fried pork skin products which meet the above criteria, which process comprises the steps of: a) contacting a raw pork skin with an alkaline aqueous solution for an effective amount of time to remove the hair from said skin; b) splitting said skin into a plurality of layers having a thickness dimension less than that of the original skin; c) removing the fat from the surface of said plurality of layers of skin; d) washing said plurality of layers of skin in water to provide a washed skin product; e) treating said washed skin product with an intenerate solution to provide a tenderized skin product; f) washing the tenderized skin product with water; g) treating the tenderized skin product with aqueous acid to provide an acidified skin product; h) treating said acidified skin product with aqueous hydrogen peroxide to provide a treated skin product; i) drying said treated skin product and cutting it into desired shapes; j) frying the treated skin product in an oil at a frying temperature to provide a fried skin product; and k) drying said fried skin product at an elevated temperature.

The manufacture of fried pork rinds is reminiscent of that of expanded polystyrene in one sense in that during their manufacture, they undergo an expansion owing to the heat-induced expansion of a gaseous substance within their bulk which does not escape into the surroundings, but rather remains entrapped within the bulk of the product after its expansion resulting in a foamed product. Fried pork rinds intended for human consumption, when snapped in half, reveal a cellular structure similar to foamed materials, such as friable polyurethane foams commonly used as insulation, such as in refrigerators. In the case of fried pork rinds, the entrapped gaseous substance comprises water, which expands under the influence of heat during the frying in hot oil stage and causes the fried pork rind as a whole to expand to many times of its original thickness prior to the frying stage. Owing to the non-uniformity of pork skins as a raw material, it is typical that a collection of fried pork rinds produced according to the invention, typically having dimensions on the order of about less than 10 centimeters long and less than about 10 centimeters wide take on a curled and/or wavy shape, reminiscent to those of fried pork rinds intended for human consumption, as is known to those skilled in the art. However, a major difference between the fried pork rinds according to the invention and those of the prior art intended for human consumption is the amount of force required to bite through each.

Fried pork rinds according to the present invention are possessed of what is referred to in this specification as a high resistance to crush stress. Resistance to crush stress with reference to fried pork rinds of the invention is readily measured by placing a fried pork rind on a firm level surface and then applying an increasing downward force per unit area (pressure) to the fried pork rind, until the fried pork rind first begins to show signs of structural failure, i.e., it begins to become crushed. According to such a technique, fried pork rinds of the prior art are readily crushed by an applied downward force of 10 pounds per square inch. However, fried pork rinds according to a preferred form of the invention do not yield when a downward force of 10 pounds per square inch is applied. Fried pork rinds according to one preferred form of the invention do not yield when a downward force of 15 pounds per square inch is applied. Fried pork rinds according to one preferred form of the invention do not yield when a downward force of 30 pounds per square inch is applied. Fried pork rinds according to one preferred form of the invention do not yield when a downward force of 40 pounds per square inch is applied. Thus, the present invention includes fried pork rind products formed from frying a pork skin, which have a density less than water and which has a resistance to crush stress that is sufficient to support any downward pressure between 10.00 and 50.00 pounds per square inch, including every hundredth pound per square inch value therebetween, when the fried pork rind product is placed on a firm level surface and the downward pressure is applied from above.

These exceptionally high yield values make a pork rind according to the invention especially well suited as pet snacks, owing to the fact that they are not readily crushed by the jaws of pet dogs. In addition, a fried pork rind according to the invention has the advantage over other chewing snacks for pets in that less raw material on a mass basis is required to provide chew snacks having a given surface area, owing to their internal foamed cellular structure, which provides a chew snack having a density less than that of water.

A process according to the present invention includes a step for removing hair from the skin. This is accomplished by contacting a raw pork skin with an alkaline aqueous solution for an effective amount of time to remove the hair from said skin. Any alkaline solution may be employed, including solutions of carbonates, oxides, and hydroxides of alkali metals and alkaline earth metals. Calcium hydroxide solutions having a pH greater than about 12 are most preferred to carry out this step, with pH levels of about 14 being most preferred. Preferably, the concentration of hydroxide is between about 10 grams per liter and 500 grams per liter, with about 100 grams per liter being particularly useful. Generally, the solution is made up in a vat or other containment vessel, and the pork skin is submersed in the solution, which is maintained at a temperature in the range of between about 10 degrees C. and 40 degrees C., with a temperature of about 25 degrees centigrade being especially preferred. Generally, treatment of a skin to remove hair in this fashion is carried out by soaking for between about 8 and 10 hours, with a treatment time of about 8 hours being typically preferred. Once the hair has been visibly removed, the skin is then rinsed with clean water to remove excess alkali or alkaline earth hydroxide.

A process according to the present invention includes a step for splitting the skin from which hair has been removed into a plurality of layers having a thickness dimension less than that of the original skin, and preferably in the range of about 4 mm to 5 mm. This is accomplished by the use of a hide splitting machine, the use of which is well-known in the art.

A process according to the present invention includes a step for removing the fat from the surface of the plurality of layers of skin which resulted from the splitting of the original skin into thinner layers. This is accomplished by mechanically scraping the surface of the skin with a flat bladed knife.

A process according to the present invention includes a step for washing the plurality of layers of skin in water after the de-fatting operation just mentioned, which provides a de-fatted, washed skin product. This step in its simplest form involves rinsing the de-fatted skins under a stream of water, but may also comprise soaking the de-fatted skins in water for a time period of about 30 minutes.

A process according to the present invention includes a step for treating the washed skin product with an intenerate solution to provide a tenderized skin product. This is accomplished according to one preferred form of the invention by preparing the intenerate solution in a wooden drum, and soaking the washed skin product in the intenerate solution, for a time period of between about 30 minutes to 1 hour, at a temperature in the range of about 15 degrees centigrade and 40 degrees centigrade, with 25 degrees centigrade being most preferred. The intenerate solution comprises aqueous ammonium chloride, having a concentration of between about 0.50% and 25.0% by weight based on the total weight of said solution. Preferably, the solution is about 10% by weight of ammonium chloride. In stead of ammonium chloride, other materials useful in intenerate solutions are suited for use in the present invention, including without limitation ammonium bicarbonate and urea (carbamide), in the same concentration range.

A process for producing a pork rind according to the present invention includes a step for washing the tenderized skin product with water, which in its simplest form comprises rinsing the tenderized skin product with a stream of water, such as by rinsing with a garden hose, but may which also be accomplished by soaking the tenderized skin product in a reservoir of clean water for about 30 minutes.

A process according to the present invention includes a step for treating the tenderized skin product with aqueous acid to provide an acidified skin product. The acid treatment step preferably involves preparing a large tub (e.g., 30 gallon size) of an acid solution, and then submerging the tenderized pork skin (after its first having been rinsed) in the acid solution. Suitable acids for this treatment step include sulfuric acid, hydrochloric (muriatic) acid, phosphoric acid, or any other acid sufficient to provide a solution having a pH of less than about 3. Dilute sulfuric of about 15% by weight concentration is especially preferred. The acid treatment step is complete once the pH has risen to any pH in the range of about 5.5 to about 7.0.

A process according to the present invention includes a step for treating the acidified skin product with aqueous hydrogen peroxide by submerging the tenderized pork skin in the aqueous hydrogen peroxide solution to provide a treated skin product. This step is accomplished by adding a 5% by weight solution of hydrogen peroxide to the drum and agitating for about 45 minutes to 1 hour. The hydrogen peroxide concentration may be any concentration in the range of between about 0.1% and 10% by weight based on the weight of the solution. The amount of peroxide is preferably about 0.3 to about 0.5% by weight based on the weight of the skin being treated.

A process according to the present invention includes a step for drying the peroxide treated skin product. The drying step preferably comprises exposing the peroxide treated skin under the sun for 3-4 days, or alternatively in a suitable drying vessel such as an oven set to between about 35 degrees centigrade and 50 degrees centigrade for 2 to 3 days. Once dry, the skin may be cut into any desired shape using a knife, die, or other conventional means for cutting pork skins known to those skilled in the art. Generally, the pork skins will be cut into substantially rectangular shapes, including squares, having length dimensions in the range of between about 2 centimeters to 25 centimeters, and having a width dimensions independently of any value in the range of between about 2 centimeters to 25 centimeters. However, any other desired shape is possible, including circular, oval, rhombohedral, hexagonal, pentagonal, triangular, or any polygon having any number of sides between about 3 and 20. According to one preferred form of the invention, the pork skins will have a total a surface area of between 8 cm² and 1250 cm².

A process according to the present invention includes a step for frying the treated skin product in an oil at a frying temperature to provide a fried skin product. The oil employed may be any oil which is known in the art as being useful for frying foods, including animal fats (lard) and vegetable oils, either natural or partially-hydrogenated, including peanut oil, sunflower oil, soybean oil, corn oil, coconut oil, flax oil, canola oil, and cottonseed oil, safflower oil, etc. The most preferred frying oil is peanut oil. It is preferred that the pork skins are fried when the oil is at any temperature in the range of between 150 degrees centigrade and 250 degrees centigrade, with 170 degrees centigrade being most preferred. Preferably, the skins are fried for a time between 30 minutes and 40 minutes, with a frying time of about 30 minutes being most preferred. Frying is preferably commenced by adding the pork skins which are at ambient temperature directly to the hot oil. According to an alternate form of the invention, instead of frying, the animal skins may be roasted at any temperature in the range of between 200 degrees centigrade and 250 degrees centigrade for a time period of between about 5 minutes and about 15 minutes.

Following the frying step, the fried pork skins are dried by exposure to sunlight for an effective time period for the skins to become dry to the touch. Fried animal skins produced by such a process according to the invention typically have a density less than water and a resistance to yield stress that is sufficient to support a downward pressure of any pressure in the range of between 10 pounds per square inch and 40 pounds per square inch, and are often substantially rectangular, having a size dimension that is in the range of between 2 cm and 25 cm long and 2 cm and 25 cm wide, and have a surface area of between about 8 cm² and about 1250 cm².

Fried animal skin products according to the present invention may also comprise added ingredients commonly added to pet products, including various colorants, spices, flavoring additives, and preservatives. In addition, fried animal skin products according to the invention may exist in collections of a wide variety of shapes and sizes.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Particularly, the methods herein are suitable for treating animal skins other than pork skins, such as cattle skins, deer skins, lambskins, etc., even though pork skins are in general preferably employed as a raw material in a process according to the invention. Accordingly, the presently disclosed invention is intended to cover all such modifications and alterations, and is limited only by the scope of the claims that follow.

1) A process for producing an edible fried animal skin comprising the steps of:
a) contacting a raw animal skin with an alkaline aqueous solution for an effective amount of time to remove the hair from said skin;
b) removing the fat from the surface of said plurality of layers of skin;
c) washing said plurality of layers of skin in water to provide a washed skin product;
d) treating said washed skin product with an intenerate solution to provide a tenderized skin product;
e) washing the tenderized skin product with water;
f) treating the tenderized skin product with aqueous acid to provide an acidified skin product;
g) treating said acidified skin product with a solution of aqueous hydrogen peroxide to provide a treated skin product;
h) drying said treated skin product and cutting it into desired shapes;
i) cooking the treated skin product to provide a cooked skin product; and
j) drying said cooked skin product to yield a pet snack grade animal skin final product.

2) A process according to claim 1 wherein said cooking step comprises frying the treated skin product in an oil at a frying temperature in the range of between 150 and 250 degrees centigrade.

3) A process according to claim 2 wherein said oil is any oil selected from the group consisting of: lard, beef tallow, partially-hydrogenated soybean oil, soybean oil, corn oil, sunflower oil, canola oil, cottonseed oil, flaxseed oil, and peanut oil.

4) A process according to claim 1 wherein said cooking step comprises roasting the treated skin product at a temperature in the range of between 180 degrees centigrade and 250 degrees centigrade for a time period between about 5 minutes and about 15 minutes.

5) A process according to claim 1 further comprising the additional step of: splitting said skin into a plurality of layers having a thickness dimension less than that of the original skin, wherein said additional step is conducted after contacting said raw animal skin with said alkaline aqueous solution, but before removing the fat from the surface of said plurality of layers of skin.

6) A process according to claim 1 wherein said animal skin is a skin of an animal selected from the group consisting of: cattle, swine, deer, and sheep.

7) A process according to claim 1 wherein said intenerate solution comprises an aqueous solution comprising a solute selected from the group consisting of: ammonium chloride, ammonium bicarbonate, and urea (carbamide), wherein the concentration of said solute is between about 0.50% and 25.0% by weight based on the total weight of said solution.

8) A process according to claim 1 wherein the amount of peroxide present in step h) is equal to between 0.3% and 0.5% of the animal skin being treated, on a weight basis.

9) A process according to claim 1 wherein the concentration of hydrogen peroxide in said aqueous solution of hydrogen peroxide is in the range of between about 0.1% and 10% by weight based on the total weight of said aqueous solution.

10) A process according to claim 1 wherein said acid is any acid selected from the group consisting of: sulfuric acid, hydrochloric acid, and phosphoric acid.

11) A cooked animal skin product according to claim 1 wherein said final product has a density less than water and which has a resistance to crush stress that is sufficient to support a downward pressure of any pressure in the range of between 10 pounds per square inch and 40 pounds per square inch without being crushed.

12) A cooked animal skin product formed from cooking an animal skin by a method selected from the group consisting of: frying and roasting, which product has a density less than water and which has a resistance to yield stress that is sufficient to support a downward pressure of any pressure in the range of between 10 pounds per square inch and 40 pounds per square inch.

13) An animal skin product according to claim 12 wherein said animal skin is substantially rectangular and has a size dimension that is in the range of between about 2 cm and about 25 cm long and about 2 cm and about 25 cm wide

14) An animal skin product according to claim 12 wherein said animal skin is substantially circular in shape.

15) An animal skin product according to claim 12 wherein said animal skin has a surface area of between about 8 cm² and about 1250 cm².

16) An animal skin product according to claim 12 which is non-planar.

17) A process for producing an edible fried animal skin comprising the steps of:
a) contacting a raw animal skin with an alkaline aqueous solution for an effective amount of time to remove the hair from said skin;
b) treating said washed skin product with an intenerate solution to provide a tenderized skin product;
c) washing the tenderized skin product with water;
d) treating the tenderized skin product with aqueous acid to provide an acidified skin product;
e) treating said acidified skin product with a solution of aqueous hydrogen peroxide to provide a treated skin product;
f) drying said treated skin product and cutting it into desired shapes;
g) frying the treated skin product in an oil at a frying temperature to provide a fried skin product; and
h) drying said fried skin product at an elevated temperature to yield a pet snack grade fried animal skin final product.

18) A process for producing a cooked animal skin product comprising the steps of:
a) contacting an animal skin with water at a temperature in the range of between 80 degrees centigrade and 100 degrees centigrade for a time period between about 7 minutes and 20 minutes;
b) removing visible fat from the surface of the skin by scraping;
c) rinsing the skin with water to provide a rinsed skin;
d) drying the rinsed skin;
e) cooking the dried rinsed skin to provide a cooked animal skin product having a resistance to yield stress that is sufficient to support a downward pressure of any pressure in the range of between 10 pounds per square inch and 40 pounds per square inch without being crushed.

19) A process according to claim 18 wherein said cooking step comprises frying the dried rinsed skin in an oil selected from the group consisting of: lard, beef tallow, partially-hydrogenated soybean oil, soybean oil, corn oil, sunflower oil, canola oil, cottonseed oil, flaxseed oil, and peanut oil at a frying temperature in the range of between 150 and 250 degrees centigrade.

20) A process according to claim 18 wherein said cooking step comprises roasting the dried rinsed skin at a temperature in the range of between 150 degrees centigrade and 250 degrees centigrade for any time period between about 5 minutes and about 15 minutes.
